(19) United States
(12) Patent Application Publication
(10) Pub. No.: US 2015/0060495 A1
(43) Pub. Date: Mar. 5, 2015

(54) Water Pitcher Having a Filter

(71) Applicant: Lincoln-Remi Group, LLC, Commerce Township, MI (US)

(72) Inventor: Steven Steinway, West Bloomfield, MI (US)

(73) Assignee: LINCOLN-REMI GROUP, LLC, Commerce Township, MI (US)

(21) Appl. No.: 14/468,664

(22) Filed: Aug. 26, 2014

Related U.S. Application Data
(60) Provisional application No. 61/873,855, filed on Sep. 5, 2013.

(51) Int. Cl. C02F 1/00; B67D 3/00

(52) U.S. Cl. CPC C02F 1/003; B67D 3/0051; B67D 3/0061; C02F 2307/04
USPC 222/189.06

(57) ABSTRACT

A water pitcher having a filter includes, among other things, a body having an open end and a closed end. A filter compartment having a bottom is positioned adjacent to the open end. A water filter extends upwardly from the bottom. A water reservoir is positioned in the body between the bottom and the closed end. The water reservoir is in fluid communication with the filter compartment through the water filter.

### TECHNICAL FIELD

The invention relates generally to water pitchers. More specifically, the invention is directed to a water pitcher having a filter.

### BACKGROUND OF THE INVENTION

Water pitchers having filters are used to purify drinking water. These types of pitchers have filter compartments positioned above water reservoirs. The filters extend downwardly from the filter compartments into the water reservoirs. Water placed in the filter compartments passes through the filters and into the water reservoirs for storage. In these types of pitchers, the filtered water in the water reservoirs is in contact with the filters during storage. This invention provides, among other things, a water pitcher in which the filtered water in the water reservoir is not in contact with the filter.

### BRIEF SUMMARY OF THE INVENTION

The invention is a water pitcher having a filter including, among other things, a body having an open end and a closed end. A filter compartment having a bottom is positioned adjacent to the open end. A water filter extends upwardly from the bottom. A water reservoir is positioned in the body between the bottom and the closed end. The water reservoir is in fluid communication with the filter compartment through the water filter.

### BRIEF DESCRIPTION OF THE DRAWINGS

FIG. 1 is a cross-sectional view taken through the center of an embodiment of a water pitcher having a filter according to the invention;

FIG. 2 is a cross-sectional view taken through the center of the filter compartment, lid and filter of the water pitcher having a filter as shown in FIG. 1;

FIG. 3 is a cross-sectional view taken through the center of the filter compartment, lid and filter of the water pitcher having a filter as shown in FIG. 1;

FIG. 4 is a cross-sectional view taken through the center of an alternative embodiment of a filter compartment, lid and filter of a water pitcher having a filter according to the invention;

FIG. 5 is a cross-sectional view taken through the center of the alternative embodiment filter compartment, lid and filter as show in FIG. 4;

FIG. 6 is a cross-sectional view taken through the center of an embodiment of a filter for a water pitcher having a filter according to the invention;

FIG. 7 is a cross-sectional view taken through the center of an alternative embodiment of a filter for a water pitcher having a filter according to the invention;

FIG. 8 is a perspective exploded view of an alternative embodiment of a filter compartment, lid and filter of a water pitcher having a filter according to the invention;

FIG. 9 is a top plan view of the lid as shown in FIG. 8;

FIG. 10 is a side elevational view of the filter compartment, lid and filter as shown in FIG. 8;

FIG. 11 is a bottom plan view of the lid as shown in FIG. 8; and

FIG. 12 is front elevational view of the filter compartment, lid and filter as shown in FIG. 8.

### DETAILED DESCRIPTION OF THE INVENTION

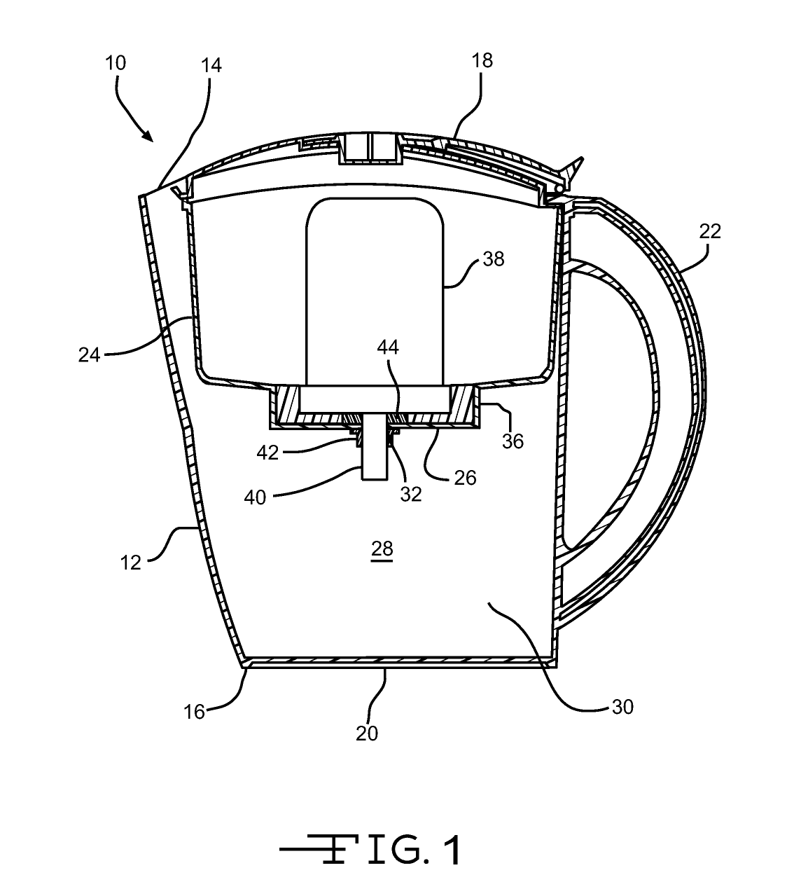

The water pitcher having a filter according to the invention will now be described in detail with reference being made to the accompanying drawings. In the drawings, the water pitcher having a filter is identified generally by the reference number “10.” Referring to FIG. 1, the water pitcher 10 includes a body 12 having an open end 14 and a closed end 16. The body 12 has a lid 18 positioned adjacent to the open end 14 and a base 20 positioned adjacent to the closed end 16. A handle 22 is positioned on the body 12.

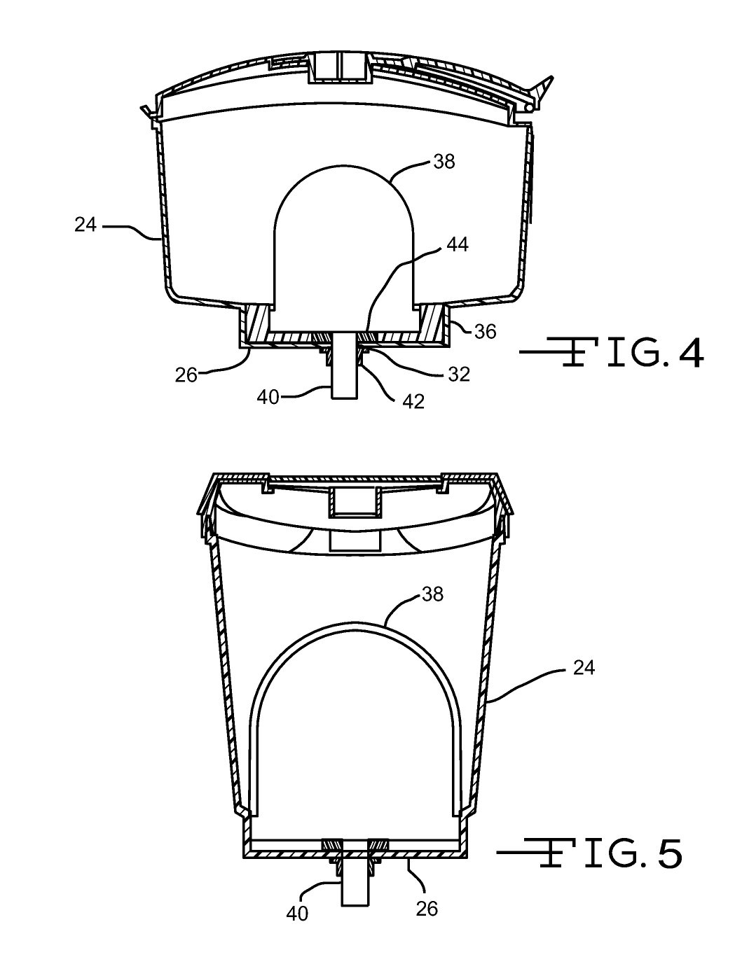

Referring to FIGS. 1-5, a filter compartment 24 having a bottom 26 is positioned adjacent to the open end 14 of the body 12. A space 28 between the bottom 26 of the filter compartment 24 and the base 20 of the body 12 forms a water reservoir 30 in the water pitcher 10.

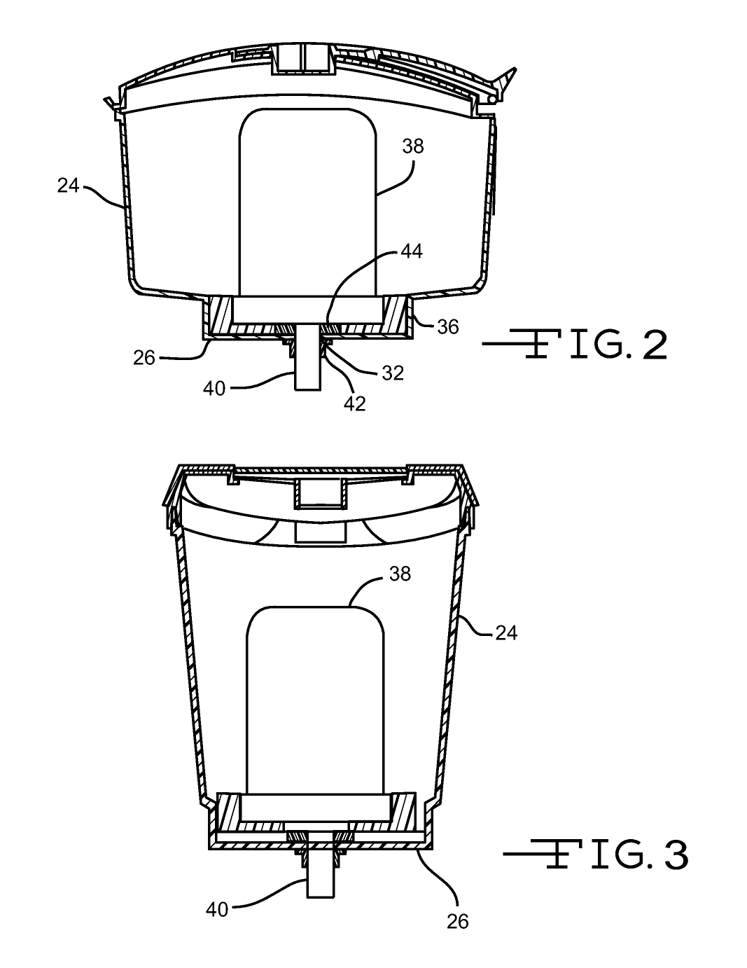

As shown in FIGS. 2-5, the filter compartment 24 includes an opening 32 in the bottom 26. In an embodiment, the filter compartment 24 has a filter recess 36 including the opening 32.

Referring to FIGS. 1-5, a water filter 38 extends upwardly from the bottom 26 of the filter compartment 24. The water filter 38 includes a conduit 40 that extends through the opening 32 into the space 28. In an embodiment, the water pitcher 10 includes an attachment device 42 for attaching the water filter 38 to the filter compartment 24. In an embodiment, an O-ring seal 44 is positioned between the water filter 38 and the bottom 26.

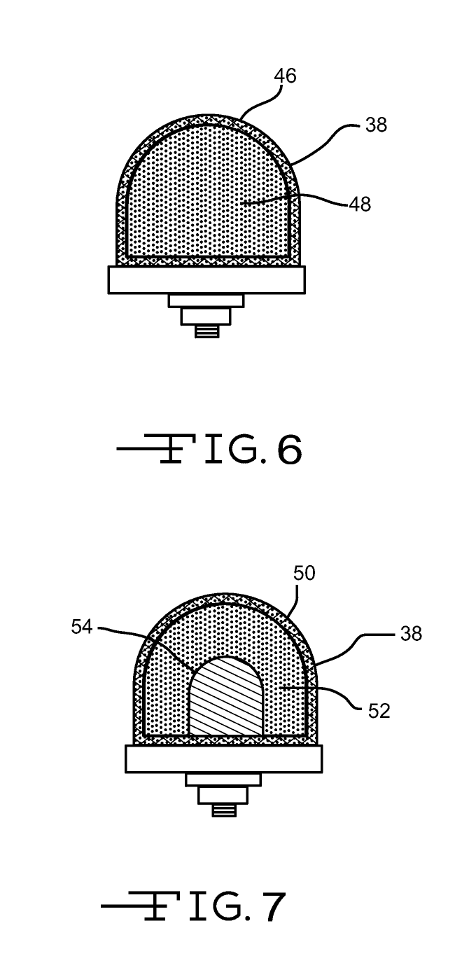

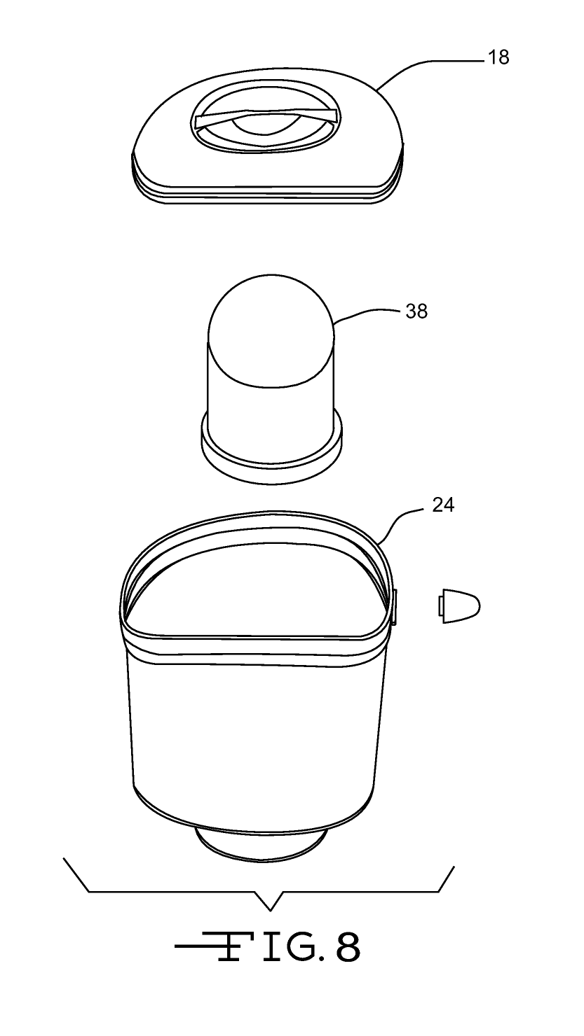

Various embodiments of water filters 38 are shown in FIGS. 1-7. For example, the water filter 38 can be a two-part filter as shown in FIG. 6 including an outer dome 46 and loose filtering media 48. The water filter 38 can also be a three-part filter as shown in FIG. 7 including an outer dome 50, loose filtering media 52, and an inner core dome 54. It should be understood that other types of water filters can be used.

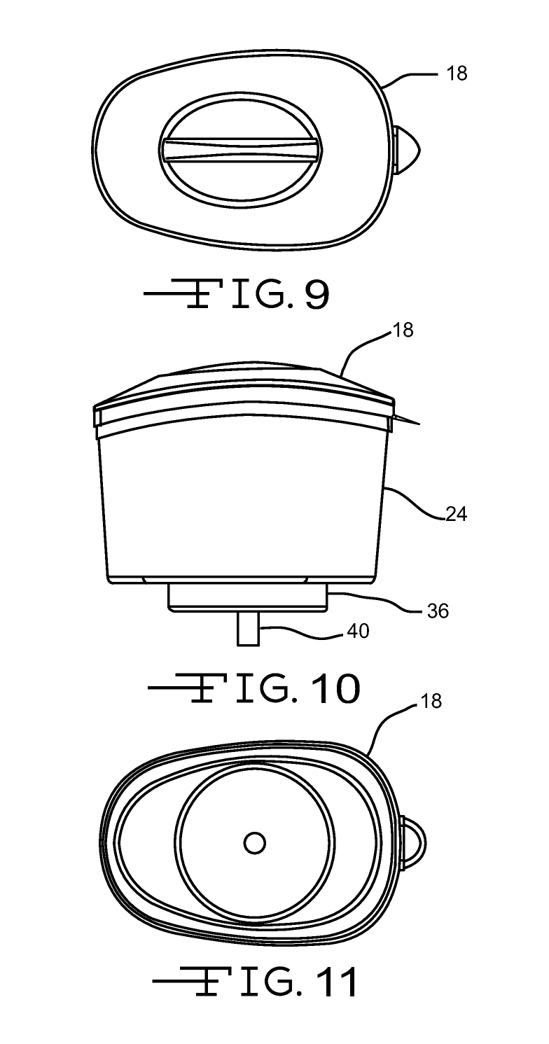

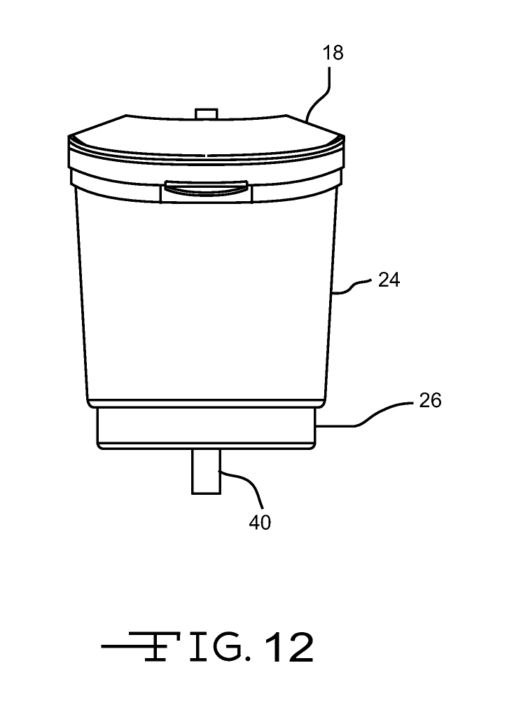

An alternative embodiment filter compartment 24, lid 18 and water filter 38 is shown in FIGS. 8-12. These components can be used with the body 12 of the water pitcher 10 as shown in FIG. 1 or other types of bodies.

The water pitcher 10 can be constructed of suitable materials. For example, the body 12, lid 18 and filter compartment 24 can be constructed of plastic. The water filter 38 can be constructed of ceramic and loose filtering media materials, such as carbon.

The operation and use of the water pitcher 10 will now be described. When water is placed in the filter compartment 24, it passes through the water filter 38 and the conduit 40 into the water reservoir 30 for storage. As it will be appreciated, the stored water is not in contact with the water filter 38 after filtering due to the positioning of the water filter 38 within the filter compartment 24. The stored water can be dispensed through the open end 14 of the body 12.

Certain embodiments of the apparatus disclosed herein are defined in various examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A water pitcher comprising a body having an open end and a closed end, a filter compartment having a bottom positioned adjacent to the open end, a water filter extending upwardly from the bottom, a water reservoir positioned in the body between the bottom and the closed end, the water reservoir being in fluid communication with the filter compartment through the water filter.

2. The water pitcher of claim 1, wherein the body has a lid positioned adjacent to the open end.

3. The water pitcher of claim 1, wherein the body has a based positioned adjacent to the closed end.

4. The water pitcher of claim 1, wherein the filter compartment has an opening in the bottom.

5. The water pitcher of claim 4, wherein the water filter has a conduit extending through the opening into the fluid reservoir.

6. The water pitcher of claim 1, wherein the filter compartment has a filter recess.

7. The water pitcher of claim 1, wherein the water pitcher has an attachment device for attaching the water filter to the filter compartment.

8. The water pitcher of claim 1, wherein the water pitcher has a seal positioned between the water filter and the bottom.
